(19) United States
(12) Patent Application Publication
(10) Pub. No.: US 2014/0227562 A1
(43) Pub. Date: Aug. 14, 2014

(54) LITHIUM SECONDARY-BATTERY PACK, ELECTRONIC DEVICE USING SAME, CHARGING SYSTEM, AND CHARGING METHOD

(71) Applicants: Haruki Kamizori, Ibaraki-shi (JP); Itaru Gosho, Ibaraki-shi (JP); Masayuki Yamada, Ibaraki-shi (JP); Fusaji Kita, Ibaraki-shi (JP)

(72) Inventors: Haruki Kamizori, Ibaraki-shi (JP); Itaru Gosho, Ibaraki-shi (JP); Masayuki Yamada, Ibaraki-shi (JP); Fusaji Kita, Ibaraki-shi (JP)

(73) Assignee: HITACHI MAXELL, LTD., Ibaraki-shi, Osaka (JP)

(21) Appl. No.: 14/241,663

(22) PCT Filed: Sep. 3, 2012
(86) PCT No.: PCT/JP2012/072367

§ 371 Date: Feb. 27, 2014

(30) Foreign Application Priority Data
Sep. 13, 2011 (JP) 2011-199055

(51) Int. Cl. H02J 7/00; H01M 2/34

(52) U.S. Cl. CPC H02J 7/0052; H01M 2/34
USPC 429/7

(57) ABSTRACT

A lithium secondary-battery pack of the present invention includes: a lithium secondary battery including an electrode body and a non-aqueous electrolyte, the electrode body including a positive electrode and a negative electrode facing each other, and a separator interposed therebetween; a PTC (Positive Temperature Coefficient) element; and a protection circuit including a field-effect transistor, wherein the negative electrode includes a negative electrode material mixture layer containing a Si-containing material as a negative electrode active material, and, where Z represents an impedance (Ω) of the lithium secondary-battery pack and Q represents a capacity (Ah) of the lithium secondary-battery pack, an impedance capacity index represented by Z/Q is 0.055 Ω/Ah or less.

### TECHNICAL FIELD

The present invention relates to a lithium secondary-battery pack having excellent fast-charging characteristics, and an electronic device, a charging system, and a charging method using the same.

### BACKGROUND ART

Non-aqueous secondary batteries including, for example, lithium secondary batteries have a high voltage and a high capacity, and thus are widely used as power sources for mobile phones, and also for various other portable devices such as smartphones and tablet terminals in recent years. They also have found medium- and large-sized applications including power tools such as electric tools, electric cars, and power-assisted bicycles.

In a standard charging method commonly used for lithium secondary batteries, when 1C is the current value with which a fully charged battery can be discharged in one hour, constant-current (CC) charging is performed with a current of about 0.7 to 1C until a predetermined end-of-charge voltage is reached. After the end-of-charge voltage has been reached, charging is switched to constant voltage (CV) charging in which the charge current is decreased so as to maintain that end-of-charge voltage.

Meanwhile, there is also a need to complete the charging of batteries as fast as possible. For example, in the case of lithium secondary batteries for mobile phones, conventional lithium secondary batteries for mobile phones can be brought into a fully charged or nearly fully charged state by being charged with a current value of 1C or less for about 2 to 4 hours. However, with the sophisticated functions of devices, such as mobile phones, to which lithium secondary batteries are applied, and with the wide spread use of smartphones and tablet terminals, which have a larger size than mobile phones, lithium secondary batteries are required to have a higher capacity. Accordingly, charging with a current value that is about the same as conventionally used current values may increase the time required to reach a fully charged state to be longer than the practical range. For example, for a battery having a high capacity exceeding 1500 mAh, the current value corresponding to 1C is relatively large, and heat resulting from charging at a large current increases the charging time with a current value less than 0.7C. Thus, in order to avoid this, there is a need to develop a technique for enabling charging with a larger current value to achieve a higher capacity, while reducing the time required for charging.

To meet this need, there have been proposed, for example, a method of enhancing fast-charging characteristics by using a plurality of positive electrode active materials in combination (Patent Document 1), a method of increasing the output (improving the load characteristics) and enhancing the fast-charging characteristics by using a lithium-titanium composite oxide for the negative electrode (Patent Document 2), and a method of ensuring favorable battery characteristics even after fast charging by adding an insulating inorganic oxide filler to the negative electrode, separately from an active material (Patent Document 3).

From the viewpoint of simply enhancing the load characteristics of lithium secondary batteries, it has been reported that the use of SiOₓ having a structure in which Si ultrafine particles are dispersed in SiO₂ as a negative electrode active material is effective (Patent Documents 4 and 5).

In the other hand, for devices, such as an electric tool, from which a battery pack is removed from the device body and charged, there has been proposed a method in which the battery pack is forcibly cooled using a cooling device provided in a charger to suppress an abrupt temperature rise due to fast charge, thereby allowing charging to be performed with a current exceeding 1C and thus reducing the charging time. (Patent Document 6).

### PRIOR ART DOCUMENTS

### Patent documents

Patent document: 1 JP 2011-076997A
Patent document 2: JP 2010-097751A
Patent document 3: JP 2009-054469A
Patent document 4: JP 2004-047404A
Patent document 5: JP 2005-259697A
Patent document 6: JP 2008-104349A

### DISCLOSURE OF INVENTION

### Problem to be Solved by the Invention

Although the conventional methods for reducing the charging time described in the above patent documents have been shown to have an adequate effect, there is a need to further enhance the fast-charging characteristics. For example, one possible way to improve the fast-charging characteristics of a lithium secondary battery is to enhance the load characteristics of the battery. However, according to the studies made by the present inventors, the use of a battery having enhanced load characteristics to construct a battery pack including a PTC element, a protection circuit, and so forth, such as the one applied to a portable device, has been shown to achieve some degree of improvement in the fast-charging characteristics, but the degree of improvement often does not reach a predicted level, proving that simply enhancing the load characteristics of the battery is not sufficient.

The present invention has been made in order to solve the above-described problems, and provides a lithium secondary-battery pack having excellent fast-charging characteristics, and an electronic device, a charging system, and a charging method using the same.

### Means for Solving Problem

In order to solve the above-described problems, a lithium secondary-battery pack of the present invention includes: a lithium secondary battery including an electrode body and a non-aqueous electrolyte, the electrode body including a positive electrode and a negative electrode facing each other, and a separator interposed therebetween, a PTC element, and a protection circuit including a field-effect transistor, wherein the negative electrode includes a negative electrode material mixture layer containing a Si-containing material as a negative electrode active material, and, where Z represents an impedance (Ω) of the lithium secondary-battery pack and Q represents a capacity (Ah) of the lithium secondary-battery pack, an impedance capacity index represented by Z/Q is 0.055 Ω/Ah or less.

An electronic device of the present invention uses the above-described lithium secondary-battery pack of the present invention.

A charging system of the present invention uses the above-described lithium secondary-battery pack of the present invention.

A charging method of the present invention uses the above-described lithium secondary-battery pack of the present invention.

### Effects of the Invention

According to the present invention, it is possible to provide a lithium secondary-battery pack having excellent fast-charging characteristics, and an electronic device, a charging system, and a charging method using the same.

### BRIEF DESCRIPTION OF DRAWINGS

FIG. 1 is a circuit diagram showing an example of a lithium secondary-battery pack according to the present invention.

FIG. 2 schematically shows an example of a lithium secondary battery included in the lithium secondary-battery pack according to the present invention, with FIG. 2A being a plan view, and FIG. 2B being a partial cross-sectional view.

FIG. 3 is a perspective view showing an example of the external appearance of the lithium secondary battery included in the lithium secondary-battery pack according to the present invention.

FIG. 4 is a graph showing an example of the relationship between the impedance and the CC charging time.

FIG. 5 is a graph showing an example of the relationship between the battery capacity and the CC charging time.

### DESCRIPTION OF THE INVENTION

In constant current (CC)-constant voltage (CV) charging of a lithium secondary-battery pack, the charge capacity per unit time is usually larger in the constant current charging period than in the constant voltage charging period. Thus, the time required from the start of charging a lithium secondary-battery pack until the lithium secondary-battery pack is fully charged can be significantly reduced by increasing the region where CC charging can be performed and increasing the charge current.

As a result of intensive studies, the present inventors found that when a battery pack having a capacity of 1.5 Ah is produced using a lithium secondary battery containing a Si-containing material as a negative electrode active material and the impedance of the battery pack is changed from 0.09Ω to 0.05Ω, the battery pack can be charged by CC charging up to 80% of the capacity of the battery pack with a current value of 1.5 C. Based on this finding, the inventors have found that by using a specific material as the negative electrode active material included in the lithium secondary battery and adjusting the impedance and the capacity of the lithium secondary-battery pack so as to have a specific relationship, it is possible to reduce a voltage increase of the lithium secondary-battery pack during charging and ensure a CC charging region that cannot be ordinarily expected, which makes it possible to minimize the attenuation of current during charging, and greatly enhance the fast-charging characteristics, thereby significantly reducing the time required from the start of charging until a fully charged state is reached without the need of a special operation such as forcibly cooling the battery pack, as compared with conventional methods in which charging is performed with a current value of 1C or less, for example. As a result, the inventors have achieved the present invention.

That is, a lithium secondary-battery pack of the present invention includes: a lithium secondary battery including an electrode body and a non-aqueous electrolyte, the electrode body including a positive electrode and a negative electrode facing each other, and a separator interposed therebetween, a PTC element, and a protection circuit including a field-effect transistor, wherein the negative electrode includes a negative electrode material mixture layer containing a Si-containing material as a negative electrode active material, and, where Z represents an impedance (Ω) of the lithium secondary-battery pack and Q represents a capacity (Ah) of the lithium secondary-battery pack, an impedance capacity index represented by Z/Q is 0.055 Ω/Ah or less. This makes it possible to improve the fast-charging characteristics of a lithium secondary-battery pack.

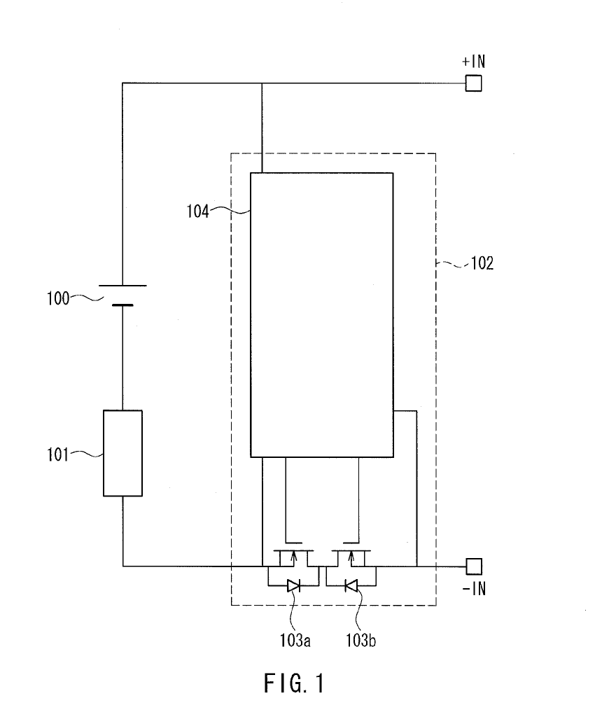

FIG. 1 shows a circuit diagram showing an example of a lithium secondary-battery pack according to the present invention. The lithium secondary-battery pack shown in FIG. 1 includes a lithium secondary battery 100, a PTC (Positive Temperature Coefficient) element (PTC thermistor) 101, a protection circuit 102, and external terminals +IN and −IN. These components are connected by a lead wire to supply power to an external load from a positive electrode terminal and a negative electrode terminal of the lithium secondary battery 100 via the external terminals +IN and −1N, or to externally charge the lithium secondary-battery pack.

The PTC element 101 has the function of interrupting the current in response to a rise in temperature. The protection circuit 102 includes a field-effect transistor (FET) 103a serving as a switching element for turning the discharge current on or off, an FET 103b serving as a switching element for turning the charge current on or off, and a control unit 104 for detecting the battery voltage and the voltage across the FETs 103a and 103b during charging and discharging, and controlling the operations of FETs 103a and 103b according to the detected voltages. The protection circuit 102 has the function of protecting the lithium secondary battery from overcharge and overdischarge, as well as overcurrent during charging and discharging. Although FIG. 1 shows an example in which two FETs that are connected in parallel, the FETs may be connected in series, or the number of FETs may be one.

For example, the lithium secondary-battery pack according to the present invention may have a structure in which the components shown in FIG. 1, such as the lithium secondary battery 100, the PTC element 101 and the protection circuit 102, are housed in an outer case.

The configuration of the lithium secondary-battery pack according to the present invention is not limited to the configuration shown in FIG. 1. For example, although FIG. 1 shows an exemplary lithium secondary-battery pack including one lithium secondary battery 100, the lithium secondary-battery pack of the present invention may have a plurality of lithium secondary batteries 100 according to the required capacity.

In the lithium secondary-battery pack of the present invention, where Z is the impedance (Ω) and Q is the capacity (Ah), the impedance capacity index represented by Z/Q is preferably 0.055 Ω/Ah or less, more preferably 0.04 Ω/Ah or less, even more preferably 0.035 Ω/Ah or less. By setting the impedance capacity index of the lithium secondary-battery pack to the above values, it is possible to increase the CC charging time during charging of the lithium secondary-battery pack, thus enhancing the fast-charging characteristics.

The impedance capacity index Z/Q is preferably as small as possible. However, due to technical limitations, it is usually 0.01 or more.

A value measured using an LCR meter under the conditions of 25° C. and 1 kHz is used as the impedance Z for calculating the impedance capacity index Z/Q.

As the capacity Q of the lithium secondary-battery pack for calculating the impedance capacity index Z/Q, a value obtained by the following method is used. Specifically, the lithium secondary-battery pack is subjected to constant current charging with a current value of 1.0C at 25° C. After the voltage value has reached 4.2 V, the lithium secondary-battery pack is further subjected to constant voltage charging with a voltage value of 4.2 V, and charging is terminated when the total charging time reaches 2.5 hours. The charged lithium secondary-battery pack is discharged at 0.2C, and discharging is stopped when the voltage value reaches 3 V. Then, the quantity of electricity discharged is determined, and the determined quantity of electricity discharged is used as the capacity Q.

The impedance capacity index Z/Q can be adjusted by controlling each of the impedance Z and the capacity Q of the lithium secondary-battery pack.

Various methods for controlling the capacity Q of the lithium secondary-battery pack, that is, the capacity of the lithium secondary battery are known, and any of such methods may be used in the present invention as long as the effects of the present invention are not impaired. The capacity Q is preferably 1.5 Ah or more, more preferably 2.0 Ah or more. As will be described later, the lithium secondary battery according to the present invention uses, as at least part of the negative electrode active material, a Si-containing material, which has a higher capacity than that of carbon materials widely used as the negative electrode active material for lithium secondary batteries, for example. The use of a Si-containing material is an example of the method for controlling the capacity of the lithium secondary-battery pack.

An example of the method for controlling the impedance Z of the lithium secondary-battery pack is the use of a material having a low resistance value for each of the lithium secondary battery, the PTC element, and the protection circuit (the FETs included therein) serving as components of the lithium secondary-battery pack, and also the lead wire for connecting these components. For example, for the PTC element and the FETs, it is preferable to select a material having a resistance value lower than that used for a conventional lithium secondary-battery pack for mobile phones (a lithium secondary-battery pack having such a capacity that the battery pack can reach a fully charged state by being charged with a current value of 1C or less for about an hour). In particular, lowering the resistance of the path as a whole by using a material having a low resistance value for the FETs or connecting the FETs in parallel can significantly contribute to a reduction in the overall impedance of the lithium secondary-battery pack. In the present invention, the impedance Z is preferably 0.085 Ω or less, more preferably 0.05 Ω or less. The lower limit is preferably 0.02 Ω or more, more preferably 0.03 Ω or more.

As described above, in order to enhance the fast-charging characteristics of the lithium secondary-battery pack, it is preferable to increase the charge current value during CC-CV charging and increase the region where charging can be performed by CC charging. Specifically, it is preferable that the capacity that can be charged by CC charging exceeds 80% of the capacity of the lithium secondary-battery pack.

In the lithium secondary-battery pack of the present invention, it is preferable that a slope k40 at an SOC of 40% on a voltage (mV)-SOC (the ratio of the charge capacity to the standard capacity) (%) curve obtained when charging is performed with a current value of 1.5C is small. The slope k40 is determined by extending the tangent at an SOC of 40% on the voltage-SOC curve from SOC 35% to SOC 45%, determining the difference between the voltages at the SOCs, and representing the obtained value as the value (mV) of voltage increase with respect to a change of an SOC of 10%. Hereinafter, in the present specification, the slope k40 is described as the voltage increase value (mV)/10% SOC.

A smaller value of the slope k40 indicates a smaller voltage increase of the lithium secondary-battery pack during CC charging and a larger chargeable capacity. Thus, the fast-charging characteristics of the lithium secondary-battery pack can be further enhanced by setting the slope k40 to a smaller value. Specifically, the slope k40 is preferably 90 mV/10% SOC or less, more preferably 50 mV/10% SOC or less, even more preferably 10 mV/10% SOC or less. Usually, the slope k40 is greater than 1 mV/10% SOC.

The slope k40 can be decreased by using a Si-containing material as the negative electrode active material of the lithium secondary battery constituting the lithium secondary-battery pack. In this case, the slope k40 can be more favorably adjusted by controlling the amount of the Si contained in the negative electrode active material per unit area (area in plan view; the same applies to the following) of the negative electrode material mixture layer to a value described below.

The lithium secondary battery of the lithium secondary-battery pack according to the present invention includes an electrode body and a non-aqueous electrolyte, the electrode body including a positive electrode including a positive electrode material mixture layer and a negative electrode including a negative electrode material mixture layer facing each other, and a separator interposed therebetween. In the following, the components of the lithium secondary battery will be described.

Negative Electrode

As the negative electrode included in the lithium secondary battery constituting the lithium secondary-battery pack according to the present invention, for example, a negative electrode, having a structure in which a negative electrode material mixture layer containing a negative electrode active material, a binder, and so forth is provided on one or both sides of a current collector, can be used.

A Si-containing material is used as the negative electrode active material contained in the negative electrode material mixture layer. This makes it possible to construct a lithium secondary battery that can form a lithium secondary-battery pack that is less susceptible to an increase in voltage during charging. Examples of the Si-containing material include Si-based active materials such as alloys, oxides, and carbides containing Si as a constituent element, and it is preferable to use a material represented by the general compositional formula SiOₓ (where the atomic ratio x of O to Si is 0.5≦x≦1.5) that contains Si and O as constituent elements. Hereinafter, a material-containing Si and O as constituent elements is referred to as “SiOₓ”. The Si-containing materials may be used alone or in a combination of two or more.

The SiOₓ is not limited to oxides of Si, and may be composite oxide of Si and another metal (e.g., B, Al, Ga, In, Ge, Sn, P, or Bi), or may contain a microcrystalline or amorphous phase of Si and another metal, as long as the overall atomic ratio x of O to Si satisfies 0.5≦x≦1.5.

Examples of the SiOₓ include materials having a structure in which Si (e.g., microcrystalline Si) is dispersed in an amorphous SiO₂ matrix. It is sufficient that the above-described atomic ratio x satisfies 0.5≦x≦1.5 when this amorphous SiO₂ and the Si dispersed therein are combined. For example, in the case of a material having a structure in which Si is dispersed in the amorphous SiO₂ matrix and the molar ratio of SiO₂ and Si is 1:1, x=1, and therefore, the material is represented as SiO in the present invention. In the case of a material having such a structure, for example, any peak attributed to the presence of Si (microcrystalline Si) may not be observed by an X-ray diffraction analysis, but an observation with a transmission electron microscope can confirm the presence of fine Si. To increase the effect of compositing with a carbon material described below and prevent micronization during charging and discharging, it is preferable to use SiO having a number average particle size of about 0.5 to 10 μm, measured with a laser diffraction scattering-type particle size distribution analyzer, for example, “Microtrac HRA” manufactured by NIKKISO CO., LTD.

Incidentally, the above-described SiO has poor conductivity. Thus, in the case of using the SiO alone as the negative electrode active material, a conductivity enhancing agent such as a carbon material is necessary from the viewpoint of ensuring favorable battery characteristics. However, rather than using a mixture obtained by simply mixing SiO with a carbon material as the negative electrode active material, it is more preferable to use a composite (hereinafter referred to as a SiOₓ/carbon composite) including a SiO serving as a core material and a carbon coating layer formed on the surface thereof. In this case, a favorable conductive network is formed in the negative electrode, making it possible to improve the load characteristics of the lithium secondary battery.

Furthermore, in the case of using a SiOₓ/carbon composite as the negative electrode active material, it is possible to improve the storage characteristics of the composite while maintaining its property of having a high capacity by optimizing the amount of carbon to be deposited on the surface of the core material and the state thereof.

The above-described SiO serving as the core material can be produced by a conventionally known method. Examples of SiO include SiO primary particles, SiO composite particles containing a plurality of SiO primary particles, and granules obtained by granulating SiO together with a carbon material for the purpose of improving the conductivity of the core material.

The above-described SiOₓ/carbon composite may be obtained, for example, by heating SiOₓ particles and a hydrocarbon-based gas in a vapor phase, and depositing carbon resulting from thermal decomposition of the hydrocarbon-based gas onto the surface of the SiOₓ particles. By producing the SiOₓ/carbon composite using chemical vapor deposition (CVD) in this manner, the hydrocarbon-based gas is distributed throughout the SiOₓ particles, so that a thin and uniform coating (carbon coating layer) containing a conductive carbon material can be formed on the surface of the particles and in the pores on the surface of the particles. Thus, it is possible to uniformly impart conductivity to the SiOₓ particles by using a small amount of the carbon material.

The treatment temperature (atmospheric temperature) in the above-described chemical vapor deposition (CVD) varies depending on the type of the above-described hydrocarbon-based gas, and ordinarily, a temperature of 600 to 1200° C. is suitable. In particular, the treatment temperature is preferably 700° C. or more, even more preferably 800° C. or more. This is because the use of a higher treatment temperature enables the formation of a coating layer having less residual impurities and containing carbon having high conductivity.

Toluene, benzene, xylene, mesitylene, or the like can be used as the liquid source for the hydrocarbon-based gas. For ease of handling, toluene is particularly preferable. The hydrocarbon-based gas can be obtained by evaporating the liquid source (for example, by bubbling with a nitrogen gas). It is also possible to use methane gas, acetylene gas, or the like.

After the surface of the SiOₓ particles is coated with a carbon material by using the chemical vapor deposition (CVD), at least one organic compound selected from the group consisting of a petroleum pitch, a coal pitch, a thermosetting resin, and a condensate of a naphthalenesulfonic acid salt and an aldehyde may be attached to the coating layer containing the carbon material, and the particles to which the organic compound has been attached may be baked. Specifically, a dispersion prepared by dispersing the SiOₓ particles, whose surface has been coated with the carbon material and the organic compound in a dispersion medium, is sprayed and dried to form particles coated with the organic compound, and the obtained particles coated with the organic compound are then baked.

An isotropic pitch can be used as the above-described pitch. A phenol resin, a furan resin, a furfural resin, or the like can be used as the above-described thermosetting resin. A naphthalene sulfonic acid formaldehyde condensate can be used as the condensate of a naphthalenesulfonic acid salt and an aldehyde.

As the dispersion medium for dispersing the SiOₓ particles whose surface has been coated with the carbon material and the organic compound, for example, water or an alcohol (e.g., ethanol) can be used. Usually, it is appropriate to carry out the spraying of the dispersion in an atmosphere of 50 to 300° C. Usually, the baking temperature is suitably 600 to 1200° C., and in particular, preferably 700° C. or more, even more preferably 800° C. or more. This is because the use of a higher treatment temperature enables the formation of a coating layer having less residual impurities and containing a high-quality carbon material having high conductivity. Note, however, that the treatment temperature needs to be equal to or less than the melting point of the SiOₓ.

There would be a significant reduction in capacity after storage when the amount of carbon deposited on the surface of the SiOₓ serving as the core material is too small, whereas the effect of using the SiOₓ, which has high capacity, may not be sufficiently achieved when the amount is too large. Thus, the amount of carbon deposited is preferably 10 to 30 mass % with respect to the total amount of the composite of the SiOₓ and the carbon material.

Since the capacity tends to drop after storage if the surface of the core material is exposed, the proportion of the core material surface that is coated with carbon is preferably as high as possible. For example, when the Raman spectrum of the SiOₓ/carbon composite is measured with a measurement laser wavelength of 532 nm, the intensity ratio I₅₁₀/I₃₄₃ between the peak intensity at 510 cm⁻¹: I₅₁₀ derived from Si and the peak intensity at I₃₄₃ cm⁻¹:I₁₃₄₃ derived from carbon (C) is preferably 0.25 or less. A smaller intensity ratio I₅₁₄/I₃₄₃ means a higher carbon coverage.

The above-described intensity ratio I₅₁₀/I₁₃₄₃ of the Raman spectrum is a value obtained by subjecting the SiOₓ/carbon composite to mapping measurement (measurement range: 80×80 μm, 2 μm step) by micro-Raman spectroscopy, averaging all the spectra within the measurement range, and determining the intensity ratio between the peak (510 cm⁻¹) derived from Si and the peak (1343 cm⁻¹) derived from C.

In the case of using the above-described SiOₓ/carbon composite as the negative electrode active material, the capacity reduction after storage may increase when the crystallite size of the Si phase contained in the core material is too small. Thus, the half-width of a Si (111) diffraction peak obtained by an X-ray diffraction method using a CuKα ray is preferably less than 3.0°, more preferably 2.5° or less. On the other hand, the initial charge-discharge capacity may decrease when the crystallite size of the Si phase is too large. Thus, the half-width of a Si (111) diffraction peak obtained by the above-described X-ray diffraction method is preferably 0.5° or more.

The average particle size D₅₀ of the SiOₓ/carbon composite is preferably 0.5 μm or more from the viewpoint of suppressing the reduction in capacity after repeated charging and discharging of the lithium secondary-battery pack, and is preferably 20 μm or less from the viewpoint of suppressing the expansion of the negative electrode due to charging and discharging of the lithium secondary-battery pack. Note that the above-described average particle size D50 is an average particle size on a volume basis measured by dispersing the SiOₓ/carbon composite in a medium that does not dissolve resin and measured using a laser scattering particle size distribution analyzer (e.g., “LA-920” manufactured by Horiba, Ltd.).

While the specific resistance value of the SiOₓ is usually 10³ to 10⁷ kΩcm, the specific resistance value of the carbon material coating the SiOₓ is usually 10⁻⁵ to 10 kΩcm.

For the above-described negative electrode included in the lithium secondary battery, another active material can be used as the negative electrode active material together with the above-described SiOₓ. As the other active material, for example, a graphite carbon material is preferable. Graphite carbon materials that are used for conventionally known lithium secondary batteries are preferable, and examples thereof include natural graphite such as flake graphite, and artificial graphite obtained by graphitizing an graphitizable carbon such as a thermally decomposed carbon, mesophase carbon microbeads (MCMB), or carbon fiber at 2800° C. or higher.

From the viewpoint of increasing the capacity of the lithium secondary battery and further improving the fast-charging characteristics of the lithium secondary-battery pack, the amount of the SiOₓ contained in the above-described negative electrode active material, in terms of Si, is preferably 0.5 mass % or more, more preferably 1 mass % or more, even more preferably 2 mass % or more. When the amount of the SiOₓ contained is large, the initial capacity increases, but the capacity of the lithium secondary battery may be reduced with charging/discharging. Accordingly, it is necessary to determine the amount of usage in consideration of a balance between the required capacity and the charge/discharge cycle characteristics. Thus, in order to suppress a capacity reduction during charging/discharging of the battery that is caused by a change in volume of the SiOₓ during charging/discharging so as to improve the charging/discharging cycle characteristics of the lithium secondary-battery pack, the amount of the SiOₓ contained in the negative electrode active material is, in terms of the amount of Si contained in the active material, preferably 20 mass % or less, more preferably 15 mass % or less, even more preferably 10 mass % or less.

For example, polyvinylidene fluoride (PVDF), polytetrafluoroethylene (PTFE), styrene-butadiene rubber (SBR), carboxymethyl cellulose (CMC), a polyacrylic acid salt, polyimide, or polyamideimide is preferably used as the binder used for the negative electrode material mixture layer.

A conductive material may be further added to the negative electrode material mixture layer as a conductivity enhancing agent. There is no particular limitation on the conductive material as long as it does not undergo a chemical change in lithium secondary battery and it is possible to use one or more of materials, including, for example, carbon blacks such as acetylene black and ketjen black, carbon nanotube, and carbon fiber.

The negative electrode according to the present invention can be produced, for example, through a process involving preparing a paste or slurry negative electrode material mixture-containing composition in which the negative electrode active material and the binder, and optionally the conductivity enhancing agent are dispersed in a solvent such as N-methyl-2-pyrrolidone (NMP) or water (however, the binder may be dissolved in the solvent), applying the composition to one or both sides of a current collector, followed by drying, and thereafter optionally performing pressing. Note, however, that the negative electrode is not limited to a negative electrode produced by the above-described production method, and may be a negative electrode produced by other production methods.

The thickness of the negative electrode material mixture layer, per side of the current collector, is preferably 10 to 100 μm. The density (calculated from the mass per unit area and the thickness of the negative electrode material mixture layer laminated on the current collector) of the negative electrode material mixture layer is preferably 1.0 to 1.9 g/cm³. As the composition of the negative electrode material mixture layer, the total amount of the negative electrode active material is preferably 80 to 99 mass %, the amount of the binder is preferably 1 to 20 mass %, and the conductivity enhancing agent (if used) is preferably used in an amount within the range in which the total amount of the negative electrode active material and the amount of the binder satisfy the above-described preferable values.

In the negative electrode according to the present invention, the amount of the Si element contained in the negative electrode active material per unit area of the negative electrode material mixture layer is preferably 0.007 mg/cm² or more, more preferably 0.018 mg/cm² or more, even more preferably 0.1 mg/cm² or more, from the viewpoint of further improving the fast-charging characteristics of the lithium secondary-battery pack. When the amount of the Si element contained is too large, the initial capacity of the lithium secondary battery increases, but the charge/discharge cycle characteristics of the lithium secondary-battery pack may deteriorate. Accordingly, the amount of the Si element contained in the negative electrode active material per unit area of the negative electrode material mixture layer is preferably less than 1.5 mg/cm², more preferably less than 1.0 mg/cm², even more preferably less than 0.5 mg/cm².

A foil, a punched metal, a mesh, an expanded metal, or the like made of copper or nickel can be used as the current collector of the negative electrode. Usually, a copper foil is used. The negative electrode current collector preferably has an upper limit thickness of 30 μm when the overall thickness of the negative electrode is reduced to obtain a high energy density battery, and it preferably has a lower limit thickness of 5 μm in order to ensure the mechanical strength.

Positive Electrode

As the positive electrode of the lithium secondary battery constituting the lithium secondary-battery pack of the present invention, it is possible to use, for example, a positive electrode having a structure including a positive electrode material mixture layer containing a positive electrode active material, a conductivity enhancing agent, a binder, and so forth on one or both sides of a current collector.

A Li (lithium)-containing transition metal oxide or the like that is capable of absorbing and desorbing Li ions is used as the positive electrode active material. Examples of the Li-containing transition metal oxide include those used for conventionally known lithium secondary batteries. Specific examples thereof include Li-containing transition metal oxides having a layered structure, such as Li_{y}CoO₂ (where 0≦y≦1.1), Li_{z}NiO₂ (where 0≦z≦1.1), LiₚMnO₂ (where 0≦p≦1.1), Li_{q}CoᵣM¹₁₋ᵣO₂ (where M¹ is at least one metal element selected from the group consisting of Mg, Mn, Fe, Ni, Cu, Zn, Al, Ti, Ge, and Cr, and 0≦q≦1.1, 0<r<1.0), LiₛNi₁₋ₜM²ₜO₂ (where M² is at least one metal element selected from the group consisting of Mg, Mn, Fe, Co, Cu, Zn, Al, Ti, Ge, and Cr, and 0≦s≦1.1, 0<t<1.0), Li_{f}MnᵥNi_{w}Co_{1-v-w}O₂ (where 0≦f≦1.1, 0<v<1.0, 0<w<1.0). One of these Li-containing transition metal oxides may be used alone, or two or more of them may be used in combination.

Various binders that are the same as those previously listed as the specific examples of the negative electrode binder can be used.

Examples of the conductivity enhancing agent include carbon materials, including, for example, graphites (graphite carbon materials) such as natural graphite (e.g., flake graphite) and artificial graphite, carbon blacks such as acetylene black, ketjen black, channel black, furnace black, lamp black, and thermal black, and carbon fiber.

The positive electrode according to the present invention can be produced, for example, through a process involving preparing a paste or slurry positive electrode material mixture-containing composition in which the positive electrode active material and the binder, and the conductivity enhancing agent are dispersed in a solvent such as NMP (however, the binder may be dissolved in the solvent), applying the composition to one or both sides of a current collector, followed by drying, and thereafter optionally performing pressing. Note, however, that the positive electrode is not limited to a positive electrode produced by the above-described production method, and may be a positive electrode produced by other production methods.

For example, the thickness of the positive electrode material mixture layer, per side of the current collector, is preferably 10 to 100 μm. The density of the positive electrode material mixture layer is calculated from the mass per unit area and the thickness of the positive electrode material mixture layer laminated on the current collector, and is preferably 3.0 to 4.5 g/cm³. As the composition of the positive electrode material mixture layer, for example, the amount of the positive electrode active material is preferably 60 to 95 mass %, the amount of the binder is preferably 1 to 15 mass %, and the amount of the conductivity enhancing agent is preferably 3 to 20 mass %.

As the current collector of the positive electrode, it is possible to use the same current collectors as those used for the positive electrode of conventionally known lithium secondary batteries. Examples thereof include a foil, a punched metal, an expanded metal, a mesh, and the like made of aluminum, stainless steel, nickel, titanium or an alloy thereof. Usually, an aluminum foil having a thickness of 10 to 30 μm is preferably used.

The above-described negative electrode and positive electrode are used for a lithium secondary battery in the form of a laminated electrode body in which they are laminated so as to face each other with a separator described below interposed therebetween, or in the form of a wound electrode body in which a laminated body in which the negative electrode and the positive electrode are laminated with the separator interposed therebetween is wound in a spiral fashion.

In the lithium secondary battery, the capacity per unit area (hereinafter referred to as a “capacity per electrode facing area”) determined by dividing the capacity (mAh) by the facing area between the positive electrode material mixture layer and the negative electrode material mixture layer (the area of the portion where they face each other with the separator interposed therebetween, expressed in cm²) is preferably less than 3.3 mAh/cm², more preferably less than 3.0 mAh/cm², even more preferably less than 2.8 mAh/cm². By using a lithium secondary battery having a small capacity per electrode facing area, it is possible to suppress the increase in battery voltage when the lithium secondary-battery pack is being fast-charged. However, when the capacity per electrode facing area is too small, the energy density of the lithium secondary battery is reduced. Thus, the capacity per electrode facing area in the lithium secondary battery is preferably 1 mAh/cm² or more.

The capacity of the lithium secondary battery used to calculate the capacity per electrode facing area is a value obtained by the following method. The lithium secondary battery is subjected to constant current charging with a current value of 1.0C at 25° C. After the voltage value has reached 4.2 V, the lithium secondary battery is further subjected to constant voltage charging at 4.2 V, and charging is terminated when the total charging time reaches 2.5 hours. The charged lithium secondary battery is discharged at 0.2C, and discharging is stopped when the voltage value reaches 3 V. Then, the quantity of electricity discharged is determined, and the determined quantity of electricity discharged is used as the capacity.

Note that when the positive electrode is smaller than the negative electrode and the entire positive electrode material mixture layer faces the negative electrode material mixture layer, the capacity per electrode facing area is a value obtained by dividing the capacity of the lithium secondary battery by the area of the positive electrode material mixture layer.

In the present invention, where P represents the mass of the positive electrode active material and N represents the mass of the negative electrode active material, P/N is preferably 1.0 to 3.6. By setting the P/N ratio to 3.6 or less, it is possible to lower the utilization rate of the negative electrode active material to limit the chargeable electric capacity, thus suppressing the above-described volume change of the negative electrode active material due to charging/discharging and suppressing the deterioration of the charge/discharge cycle characteristics of the lithium secondary-battery pack, for example, due to pulverization of the negative electrode active material particles. By setting the P/N ratio to 1.0 or more, it is possible to ensure a high battery capacity.

Separator

As a separator of the lithium secondary battery constituting the lithium secondary-battery pack according to the present invention, it is preferable to use a separator having a sufficient strength and being capable of retaining a large amount of a non-aqueous electrolyte. For example, it is possible to use a microporous film having a thickness of 5 to 50 μm and a porosity of 30 to 70% and made of polyolefin such as polyethylene (PE) or polypropylene (PP). The microporous film constituting the separator may be a microporous film made of only PE or only PP, for example, may contain an ethylene-propylene copolymer, or may be a laminate of a PE microporous film and a PP microporous film.

As the separator, it is possible to use a laminated separator including a porous layer (A) composed mainly of a resin having a melting point of 140° C. or less and a porous layer (B) composed mainly of a resin having a melting point of 150° C. or more or an inorganic filler having a heat-resistant temperature of 150° C. or more. As used herein, “melting point” refers to a melting temperature measured using a differential scanning calorimeter (DSC) in accordance with the Japanese Industrial Standards (JIS) K 7121, and “having a heat-resistant temperature of 150° C. or more” means that no deformation such as softening is observed at least at 150° C.

The porous layer (A) included in the laminated separator serves mainly to ensure a shutdown function. When the temperature of the lithium secondary battery reaches a melting point or more of the resin serving as the main component of the porous layer (A), the resin contained in the porous layer (A) melts to close the pores of the separator, causing a shutdown that suppresses the electrochemical reaction from proceeding.

The resin serving as the main component of the porous layer (A) and having a melting point of 140° C. or less may be, for example, PE, and may have, for example, a configuration in which PE particles are applied to a substrate such as a microporous film or nonwoven fabric for use in a lithium secondary battery. Here, the volume of the resin serving as the main component and having a melting point of 140° C. or less in all components of the porous layer (A) is preferably 50 vol % or more, more preferably 70 vol % or more. In the case of forming the porous layer (A) by using the PE microporous film, the volume of the resin having a melting point of 140° C. or less is 100 vol %.

The porous layer (B) included in the laminated separator has the function of preventing a short circuit resulting from a direct contact between the positive electrode and the negative electrode even if the internal temperature of the lithium secondary battery has increased. This function is ensured by a resin having a melting point of 150° C. or more, or an inorganic filler having a heat-resistant temperature of 150° C. or more. More specifically, even if the porous layer (A) has shrunk when the battery is heated to a high temperature, the porous layer (B), which does not easily shrink, can prevent a short circuit resulting from a direct contact between the positive and negative electrodes that may occur when the separator undergoes heat shrinkage. Furthermore, the heat-resistant porous layer (B) serves as the skeleton of the separator, and therefore the heat shrinkage of the porous layer (A), that is, the heat shrinkage of the separator as a whole can be suppressed.

When the porous layer (B) is formed using the resin having a melting point of 150° C. or more as the main component, the porous layer (B) may have, for example, a configuration in which a microporous film (e.g., the above-described PP microporous film for use in batteries) formed of a resin having a melting point of 150° C. or more is laminated on the porous layer (A), or a coated/laminated configuration in which a composition (coating liquid) for forming a porous layer (B) containing fine particles of a resin having a melting point of 150° C. or more is applied to the porous layer (A) to laminate the porous layer (B) containing fine particles of the resin having a melting point of 150° C. or more.

Examples of the resin constituting fine particles of the resin having a melting point of 150° C. or more include PP, various cross-linked polymers such as cross-linked polymethyl methacrylate, cross-linked polystyrene, cross-linked polydivinylbenzene, a cross-linked styrene-divinylbenzene copolymer, polyimide, a melamine resin, a phenol resin, and a benzoguanamine-formaldehyde condensate, polysulfone, polyether sulfone, polyphenylene sulfide, polytetrafluoroethylene, polyacrylonitrile, aramid, and polyacetal.

For example, the particle size of the fine particles, as the average particle size, is preferably 0.01 μm or more, more preferably 0.1 μm or more, and is preferably 10 μm or less, more preferably 2 μm or less. For example, the average particle size of the fine particles is an average particle size (D50) measured using a laser scattering particle size distribution analyzer (e.g., “LA-920” manufactured by Horiba, Ltd.) by dispersing the fine particles in a medium that does not dissolve resin.

The amount of the fine particles in the total volume (the volume excluding the pore portion) of all components of the porous layer (B) is 50 vol % or more, and preferably 70 vol % or more, more preferably 80 vol % or more, even more preferably 90 vol % or more.

When the porous layer (B) is formed using an inorganic filler having a heat-resistant temperature of 150° C. or more as the main component, examples of the configuration include a coated/laminated configuration in which a composition (coating liquid) for forming a porous layer (B) containing an inorganic filler having a heat-resistant temperature of 150° C. or more is applied to the porous layer (A) to laminate the porous layer (B) containing the inorganic filler having a heat-resistant temperature of 150° C. or more.

The inorganic filler may be any material as long as it has a heat-resistant temperature of 150° C. or more, is stable in the non-aqueous electrolyte included in the lithium secondary battery, and also is electrochemically stable, that is, is not easily oxidized or reduced in the range of operating voltages of the lithium secondary battery. In terms of dispersibility, for example, the inorganic filler is preferably in the form of fine particles, and alumina, silica, and boehmite are preferable. Since alumina, silica, and boehmite are highly resistant to oxidation, and the particle size and shape can be adjusted to desired numerical values, the porosity of the porous layer (B) can be easily controlled with accuracy. For example, one of the above-listed examples may be used alone or two or more of them may be used in combination as the inorganic filler. The inorganic filler having a heat-resistant temperature of 150° C. or more and the fine particles of the resin having a melting point of 150° C. or more may be used in combination.

There is no limitation on the shape of the inorganic filler, and it is possible to use an inorganic filler having a substantially spherical shape (including a spherical shape), a substantially ellipsoidal shape (including an ellipsoidal shape), or a plate-like shape.

When the average particle size (the average particle size of a plate-like filler and a filler of any other shape; the same applies to the following) of the inorganic filler is too small, the ion permeability is reduced. Thus, the average particle size is preferably 0.3 μm or more, more preferably 0.5 μm or more. When the inorganic filler is too large, the electrical properties tend to deteriorate. Thus, the average particle size of the inorganic filler is preferably 5 μm or less, more preferably 2 μm or less. As used herein, the average particle size of the inorganic filler having a heat-resistant temperature of 150° C. or more is an average particle size (D50) determined by the same method as that used for the average particle size of the fine particles of the resin having a melting point of 150° C. or more.

The amount of the inorganic filler in the total volume of all components of the porous layer (B) (the total volume excluding the pore portion) is 50 vol % or more, and preferably 70 vol % or more, more preferably 80 vol % or more, even more preferably 90 vol % or more. By setting the inorganic filler content high as above, if the lithium secondary battery is heated to a high temperature, the heat shrinkage of the separator as a whole can be better suppressed, and the occurrence of a short circuit resulting from a direct contact between the positive electrode and the negative electrode can be even better suppressed.

Preferably, the porous layer (B) contains an organic binder for binding the fine particles of the resin having a melting point of 150° C. or more, binding particles of the inorganic filler having a heat-resistant temperature of 150° C. or more, or integrating the porous layer (B) and the porous layer (A) with each other. Examples of the organic binder include an ethylene-vinyl acetate copolymer (EVA, containing 20 to 35 mol % of a structural unit derived from vinyl acetate), an ethylene-acrylic acid copolymer such as an ethylene-ethyl acrylate copolymer, fluorine-based rubber, SBR, CMC, hydroxyethyl cellulose (HEC), polyvinyl alcohol (PVA), polyvinyl butyral (PVB), polyvinyl pyrrolidone (PVP), cross-linked acrylic resin, polyurethane, and epoxy resin. Of these, a heat-resistant binder having a heat-resistant temperature of 150° C. or more is preferably used. As the organic binder, one of the above-listed examples may be used alone, or two or more of them may be used in combination.

The composition for forming the porous layer (B) is a composition containing the fine particles of the resin having a melting point of 150° C. or more or the inorganic filler having a heat-resistant temperature of 150° C. or more, and optionally the above-described organic binder and the like, and in which these are dispersed in a solvent (including a dispersing medium; the same applies to the following). Any solvent may be used for the solvent for use in the composition for forming the porous layer (B), as long as the inorganic filler or the like can be uniformly dispersed therein and the organic binder can be uniformly dissolved or dispersed therein. For example, commonly used organic solvents, including, for example, aromatic hydrocarbons such as toluene, furans such as tetrahydrofuran, and ketones such as methyl ethyl ketone and methyl isobutyl ketone can be preferably used.

In the composition for forming the porous layer (B), the solid content including the fine particles of the resin having a melting point of 150° C. or more or the inorganic filler having a heat-resistant temperature of 150° C. or more, the organic binder, and the like is preferably 10 to 80 mass %, for example.

The thickness of the separator made of a polyolefin microporous film or the above-described laminated separator is preferably 10 to 30 μm.

In the laminated separator, the thickness (in the case of a separator including a plurality of porous layers (B), the total thickness thereof) of the porous layer (B) is preferably 3 μm or more, from the viewpoint of effectively achieving the above-described functions of the porous layer (B). However, a porous layer (B) that is too thick may cause, for example, a reduction in energy density of the battery. Thus, the thickness of the porous layer (B) is preferably 8 μm or less.

Furthermore, in the laminated separator, the thickness (in the case of a separator including a plurality of porous layers (A), the total thickness thereof, the same applies to the following) of the porous layer (A) is preferably 6 μm or more, more preferably 10 μm or more, from the viewpoint of more effectively achieving the functions (in particular, the shutdown function) of the porous layer (A). However, a porous layer (A) that is too thick may cause a reduction in energy density of the battery, and also result in a greater force acting on the porous layer (A) to heat shrink, which may reduce the effect of suppressing the heat shrinkage of the separator as a whole. Thus, the thickness of the porous layer (A) is preferably 25 μm or less, more preferably 20 μm or less, even more preferably 14 μm or less.

To achieve good ion permeability by ensuring the amount of an electrolytic solution retained, the overall porosity of the separator, in a dry state, is preferably 30% or more. On the other hand, from the viewpoint of ensuring the strength of the separator and preventing the internal short circuit, the porosity of the separator, in a dry state, is preferably 70% or less. The porosity, P (%) of the separator, can be calculated by determining the total sum of components i using Formula (I) below from the thickness of the separator, the mass per unit area of the separator, and the densities of the components.

P={1−(m/t)/(Σaᵢ·pᵢ)}×100 (1)

In the above formula, aᵢ is the ratio of component i when the total mass is taken as 1, ρᵢ is the density (g/cm³) of component i, m is the mass per unit area (g/cm²) of the separator, and t is the thickness (cm) of the separator.

In the case of the laminated separator, the porosity, P (%) of the porous layer (A), can also be determined using Formula (I) above by taking m as the mass per unit area (g/cm²) of the porous layer (A) and t as the thickness (cm) of the porous layer (A). The porosity of the porous layer (A) determined by this method is preferably 30 to 70%.

Furthermore, in the case of the laminated separator, the porosity, P (%) of the porous layer (B), can also be determined using Formula (I) above by taking m as the mass per unit area (g/cm²) of the porous layer (B) and t as the thickness (cm) of the porous layer (B). The porosity of the porous layer (B) determined by this method is preferably 20 to 60%.

In the laminated electrode body and the wound electrode body used for the lithium secondary battery, in the case of using the laminated separator, in particular, in the case of using a separator in which a porous layer (B) composed mainly of an inorganic filler having a heat-resistant temperature of 150° C. or more is laminated on a porous layer (A) composed mainly of a resin having a melting point of 140° C. or less, it is preferable that the separator is disposed such that the porous layer (B) faces at least the positive electrode. In this case, the porous layer (B) composed mainly of an inorganic filler having a heat-resistant temperature 150° C. or more and thus having higher resistance to oxidation faces the positive electrode, and thereby the oxidation of the separator caused by the positive electrode can be even better suppressed. Accordingly, it is also possible to improve the high-temperature storage characteristics and the charge/discharge cycle characteristics of the battery. When an additive such as vinylene carbonate or cyclohexyl benzene is added to a non-aqueous electrolyte, which will be described later, a film may be formed on the positive electrode side and close the fine pores of the separator, causing a significant deterioration of the battery characteristics. Therefore, by causing the porous layer (B), which is relatively porous, to face the positive electrode, the effect of suppressing the clogging of fine pores can also be expected.

In the other hand, when one surface of the laminated separator is the porous layer (A), it is preferable that the porous layer (A) faces the negative electrode. In this case, the thermoplastic resin that has been melted from the porous layer (A) is less likely to be absorbed by the electrode material mixture layer in the event of shutdown than in the case where the porous layer (A) is disposed on the positive electrode side. Accordingly, most of the melted thermoplastic resin can be used to close the pores of the separator. Thus, the shutdown effect can be further enhanced.

Non-Aqueous Electrolyte

One example of a non-aqueous electrolyte included in the lithium secondary battery constituting the lithium secondary-battery pack according to the present invention is an electrolytic solution prepared by dissolving either or both of an inorganic lithium salt and an organic lithium salt in any of the following solvents.

Examples of the solvent include aprotic organic solvents such as ethylene carbonate (EC), propylene carbonate (PC), butylene carbonate (BC), vinylene carbonate (VC), dimethyl carbonate (DMC), diethyl carbonate (DEC), methyl ethyl carbonate (MEC), γ-butyrolactone, 1,2-dimethoxy ethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphate triester, trimethoxymethane, a dioxolane derivative, sulfolane, 3-methyl-2-oxazolidinone, a propylene carbonate derivative, a tetrahydrofuran derivative, diethyl ether, and 1,3-propanesultone. These may be used alone or in a combination of two or more.

Examples of the inorganic lithium salt include LiClO₄, LiBF₄, LiPF₆, LiCF₃SO₃, LiCF₃CO₂, LiAsF₆, LiSbF₆, LiB₁₀Cl₁₀, lower aliphatic lithium carboxylate, LiAlCl₄, LiCl, LiBr, LiI, chloroborane Li, and Li tetraphenylborate. These may be used alone or in combination of two or more.

Examples of the organic lithium salt include LiCF₃SO₃, LiCF₃CO₂, Li₂C₂F₄(SO₃)₂, LiN(CF₃SO₂)₂, LiC(CF₃SO₂)₃, LiCₙF₂ₙ₊₁SO₃(2≦n≦7), and LiN(Rf¹OSO₂)₂ (where Rf¹ is a fluoroalkyl group). These may be used alone or in combination of two or more.

For example, the concentration of the lithium salt contained in the non-aqueous electrolytic solution is preferably 0.2 to 3.0 mol/dm³, more preferably 0.5 to 1.5 mol/dm³, even more preferably 0.9 to 1.3 mol/dm³.

As the non-aqueous electrolytic solution, it is particularly preferable to use an electrolytic solution in which LiPF₆ is dissolved in a solvent containing at least one chain carbonate selected from the group consisting of dimethyl carbonate, diethyl carbonate, and methyl ethyl carbonate, and at least one cyclic carbonate selected from the group consisting of ethylene carbonate and propylene carbonate.

For the purpose of improving the charge/discharge cycle characteristics and enhancing safety such as high-temperature storage characteristics and overcharge prevention, the non-aqueous electrolytic solution may contain additives shown below as appropriate. Examples of the additive include acid anhydride, sulfonic acid ester, dinitrile, 1,3-propanesultone, diphenyl disulfide, cyclohexyl benzene, vinylene carbonate (VC), biphenyl, fluorobenzene, t-butyl benzene, cyclic fluorinated carbonate (e.g., trifluoropropylene carbonate (TFPC) and fluoroethylene carbonate (FEC)) or chain fluorinated carbonate (trifluorodimethyl carbonate (TFDMC), trifluorodiethyl carbonate (TFDEC), and trifluoroethyl methyl carbonate (TFEMC)), fluorinated ether (Rf²—OR, where Rf² is an alkyl group containing fluorine, and R is an organic group that may contain fluorine)), phosphoric ester (ethyl diethyl phosphonoacetate (EDPA): (C₂H₅O)₂(P═O)—CH₂(C═O)OC₂H₅), and tris(trifluoroethyl) phosphate (TFEP): (CF₃CH₂O)₃P═O, triphenyl phosphate (TPP): (C₆H₅O)₃P═O (including derivatives of the above compounds). As described above, the pulverization of the particles due to volume contraction/expansion of the SiOₓ/carbon composite can be suppressed by limiting the P/N ratio between the positive electrode and the negative electrode. By adding TFPC to the non-aqueous electrolytic solution, a coating film is formed on the particle surface of the SiOₓ/carbon composite, so that even if cracks or the like occur in the particle surface as a result of repeated charging and discharging and a newly generated surface is exposed, the above-described TFPC covers the newly generated surface. Accordingly, it is possible to suppress a capacity deterioration due to charge/discharge cycles. Furthermore, since TFPC has higher resistance to oxidation-reduction as compared with FEC, it is less likely to cause an extra decomposition reaction (e.g., generation of gas) other than the formation of a coating film, and serves to suppress exothermic reaction due to decomposition reaction to inhibit an increase in internal temperature of the lithium secondary battery.

The non-aqueous electrolytic solution may also be used in the form of a gel electrolyte using a known gelling agent such as a polymer.

There is no particular limitation on the configuration of the lithium secondary battery included in the lithium secondary-battery pack of the present invention. For example, it may have any shape such as a coin shape, a button shape, a sheet shape, a laminated configuration, a cylindrical shape, a flat shape, a square shape, or may take a large-scale configuration for use in an electric car and the like.

In introducing a positive electrode, a negative electrode, and a separator into the lithium secondary battery, they may be formed into a laminated electrode body in which a plurality of positive electrodes and a plurality of negative electrodes are laminated with a separator interposed therebetween or a wound electrode body in which a positive electrode and a negative electrode are laminated with a separator disposed therebetween and the whole is further wound in a spiral fashion, in accordance with the configuration of the battery.

The lithium secondary-battery pack of the present invention can improve the capacity and ensure favorable fast-charging characteristics. Thus, by utilizing these characteristics, the lithium secondary-battery pack can be preferably used for a power source of small and multi-functional portable devices and various applications to which conventionally known lithium secondary-battery packs are used. For example, when the lithium secondary-battery pack of the present invention is installed in a charging device that has conventionally been in wide use (e.g., a constant current-constant voltage charging device or a pulse charging device), it is possible to construct a charging system of the present invention that is capable of fast charging. With this charging system, it is possible to perform a charging method of the present invention that is capable of fast charging.

### EXAMPLES

Hereinafter, the present invention will be described in detail by way of examples. It should be noted, however, that the examples given below are not intended to limit the present invention.

### Example 1

### Production of Positive Electrode

Eighty parts by mass of LiCoO₂ and 20 parts by mass of LiMn0.2Ni_{0.6}Co_{0.2}O₂ each serving as a positive electrode active material, 1 part by mass of artificial graphite and 1 part by mass of ketjen black each serving as a conductivity enhancing agent, and 10 parts by mass of PVDF serving as a binder were uniformly mixed with an NMP serving as a solvent, to prepare a positive electrode material mixture-containing paste. The obtained positive electrode material mixture-containing paste was then intermittently applied onto both sides of a current collector made of an aluminum foil and having a thickness 15 μm so as to have a controlled thickness, and dried. Thereafter, the resulting structure was subjected to calendering to adjust the thickness of the positive electrode material mixture layer such that the total thickness was 120 μm, and cut to have a width of 54.5 mm, to produce a positive electrode. Furthermore, a tab was welded to an exposed portion of the aluminum foil of this positive electrode to form a lead portion.

Production of Negative Electrode

Ninety eight parts by mass of a mixture prepared by mixing a material obtained by coating the surface of SiO with carbon (having an average particle size D50 of 5 μm; hereinafter referred to as “SiO/carbon composite”) and graphite carbon having an average particle size D50 of 16 μm each serving as a negative electrode active material at a mass ratio of 5:95, and 1.0 part by mass of a CMC aqueous solution at a concentration of 1 mass % and having a viscosity adjusted to 1500 to 5000 mPa·s and 1.0 part by mass of SBR each serving as a binder were mixed with ion exchanged water having a specific conductance of 2.0×10⁵ Ω/cm or more as a solvent, to prepare an aqueous negative electrode material mixture-containing paste.

In the SiO/carbon composite, the coated amount of carbon was 20 mass %, and the I₅₁₀/I₁₃₄₃ intensity ratio of the Raman spectrum at a measurement laser wavelength of 532 nm was 0.10, and the half-width of a Si (111) diffraction peak obtained by the X-ray diffraction measurement of SiO using a CuKα ray was 1.0°.

Then, the above negative electrode material mixture-containing paste was intermittently applied onto both sides of a current collector made of a copper foil and having a thickness of 8 μm so as to have a controlled thickness, and dried. Thereafter, the resulting structure was subjected to calendering to adjust the thickness of the negative electrode material mixture layer such that the total thickness was 108 μm, and cut to have a width of 55.5 mm, to produce a negative electrode. Furthermore, a tab was welded to an exposed portion of the copper foil of this negative electrode to form a lead portion.

The area of the negative electrode material mixture layer in the negative electrode was 599 cm², and the amount of the Si contained in the negative electrode active material per unit area of the negative electrode material mixture layer was 0.14 mg/cm².

Production of Separator

The 5 kg of ion exchanged water and 0.5 kg of a dispersing agent (aqueous polycarboxylic acid ammonium salt, having a solid content concentration of 40 mass %) were added to 5 kg of boehmite having an average particle size D50 of 1 μm, and the resulting mixture was subjected to a crushing treatment in a ball mill having an internal volume of 20 L for 10 hours at a rotation speed of 40 rpm, to prepare a dispersion. The treated dispersion was vacuum dried at 120° C., and observed using a scanning electron microscope (SEM), as a result of which it was found that boehmite was substantially plate-shaped.

The 0.5 g of xanthan gum as a thickener and 17 g of a resin binder dispersion (modified poly(butyl acrylate), having a solid content of 45 mass %) as a binder were added to 500 g of the above dispersion, and the resulting mixture was stirred with a stirrer for three hours to prepare a uniform slurry (porous layer (B) forming slurry, having a solid content of 50 mass %).

Then, a corona discharge treatment (discharge amount: 40 W·min/m²) was performed on one surface of a PE microporous separator (a porous layer (A) having a thickness of 12 μm, a porosity of 40%, an average pore size of 0.08 μm, and a PE melting point of 135° C.) for a lithium secondary battery. The porous layer (B) forming slurry was applied to the treated surface using a micro-gravure coater, and dried to form a porous layer (B) having a thickness of 4 μm, thus yielding a laminated separator. In this separator, the mass per unit area of the porous layer (B) was 5.5 g/m², the volumetric boehmite content was 95 vol %, and the porosity was 45%.

Preparation of Non-Aqueous Electrolytic Solution

LiPF₆ as a lithium salt was dissolved at a concentration of 1.1 mol/dm³ in a solvent mixture prepared by mixing EC, MEC, and DEC at a volume ratio of 1.0:0.5:1.5, and VC, FEC, and EDPA were further added thereto in amounts to of 2.5 mass %, 1.75 mass %, and 1.00 mass %, respectively, to prepare a non-aqueous electrolytic solution.

Assembly of Battery

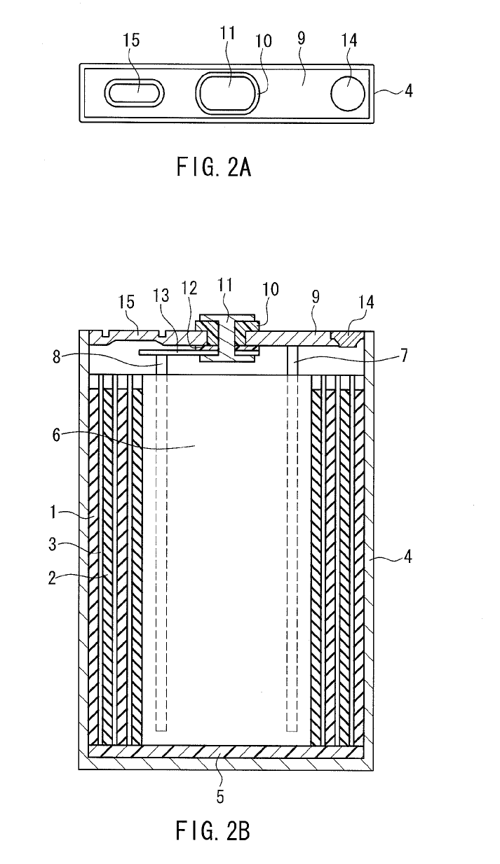

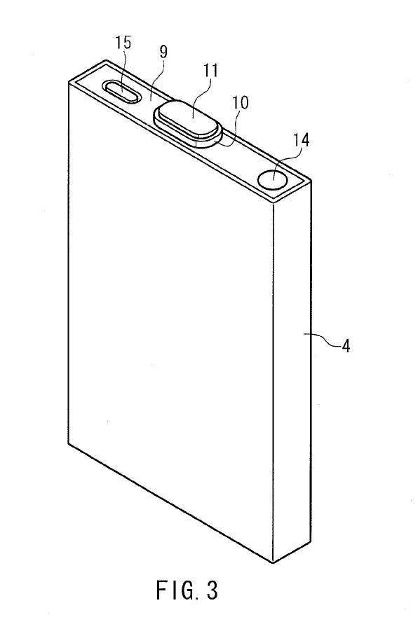

The positive electrode and the negative electrode produced above were placed upon each other with the above separator interposed therebetween such that the porous layer (B) of the separator faced the positive electrode, and wound in a spiral fashion to produce a wound electrode body. The obtained wound electrode body was pressed into a flat shape, then placed in an outer can made of an aluminum alloy and having a thickness of 5 mm, a width of 42 mm, and a height of 61 mm, and the above non-aqueous electrolytic solution was injected into the outer can. Then, after the injection of the non-aqueous electrolytic solution, the outer can was sealed to produce a lithium secondary battery having the structure shown in FIGS. 2A and 2B and the external appearance shown in FIG. 3.

Here, a description will be given of the battery shown in FIGS. 2A, 2B, and 3. FIG. 2A is a plan view and FIG. 2B is a partial cross-sectional view. As shown in FIG. 2B, a positive electrode 1 and a negative electrode 2 are wound in a spiral fashion with a separator 3 interposed therebetween, and thereafter pressed into a flat shape to form a flat wound electrode body 6, which is housed in an outer can 4 having the shape of a rectangular cylinder, together with a non-aqueous electrolytic solution. Note that in order to simplify the illustration, the metal foils serving as current collectors, the electrolytic solution, and so forth that were used for producing the positive electrode 1 and the negative electrode 2 are not shown in FIG. 2B. Also, the layers of the separator are not shown.

The outer can 4, which is made of an aluminum alloy, constitutes the outer case of the battery. The outer can 4 also serves as a positive electrode terminal. At the bottom of the outer can 4 is disposed an insulator 5 made of a PE sheet. A positive electrode lead body 7 and a negative electrode lead body 8 connected to the ends of the positive electrode 1 and the negative electrode 2, respectively, are drawn from the flat wound electrode body 6 composed of the positive electrode 1, the negative electrode 2, and the separator 3. A stainless steel terminal 11 is attached to a sealing cover plate 9 made of an aluminum alloy for sealing the opening of the outer can 4 via a PP insulating packing 10. A stainless steel lead plate 13 is attached to the terminal 11 via an insulator 12.

The cover plate 9 is fitted within the opening of the outer can 4, and the joint between them is welded to seal the opening of the outer can 4, thus sealing the interior of the battery. In the battery shown in FIGS. 2A and 2B, the cover plate 9 is provided with a non-aqueous electrolytic solution inlet 14. The non-aqueous electrolytic solution inlet 14 is sealed by, for example, laser welding with a sealing member inserted therein, thus ensuring sealing of the battery. Therefore, the non-aqueous electrolytic solution inlet 14 of the battery of FIGS. 2A, 2B, and 3 is actually constituted by a non-aqueous electrolytic solution inlet and a sealing member, but they are shown as the non-aqueous electrolytic solution inlet 14 in order to simplify the illustration. The lid plate 9 is further provided with a rupture vent 15 serving as a mechanism for discharging internal gas to the outside in the event of a temperature rise in the battery.

In this lithium secondary battery of Example 1, the positive electrode lead body 7 is directly welded to the cover plate 9, so that the outer can 4 and the cover plate 9 can function as a positive terminal. Moreover, the negative electrode lead body 8 is welded to the lead plate 13, and thus electrically connected to the terminal 11 via the lead plate 13, so that the terminal 11 can function as a negative terminal. However, the positive and negative electrodes may be reversed depending on the material of the outer can 4 or the like.

FIG. 3 is a perspective view schematically showing the external appearance of the above-described battery shown in FIGS. 2A and 2B. FIG. 3 is illustrated to indicate that the battery is a square battery. In FIG. 3, the battery is schematically shown and only specific components of the battery are illustrated. Likewise, in FIG. 2B, hatching indicating cross sections is omitted for the central portion of the wound electrode body 6 and the separator 3.

For the above lithium secondary battery of Example 1, the impedance was 0.033 Ω, and the capacity per electrode facing area was 2.8 mAh/cm².

Assembly of Lithium Secondary-Battery Pack

The lithium secondary battery of Example 1, a protection circuit including two FETs connected in parallel, each having a resistance value of 0.01 Ω, and a PTC element having a resistance value of 0.01 Ω were used. These components were connected to each other with a lead wire as shown in FIG. 1, and housed in an outer case to assemble a lithium secondary-battery pack of Example 1.

For the lithium secondary-battery pack of Example 1, the impedance determined by the above-described method was 0.050 Ω, the capacity determined by the above-described method was 1.55 Ah, and the impedance capacity index was 0.032 Ω/Ah.

### Example 2

A lithium secondary battery of Example 2 was produced in the same manner as in Example 1 except that a Si alloy was used as the negative electrode active material in place of the SiO/carbon composite. For the obtained lithium secondary battery of Example 2, the impedance was 0.034 Ω, and the capacity per electrode facing area was 2.8 mAh/cm².

A lithium secondary-battery pack of Example 2 was produced in the same manner as in Example 1 except that the lithium secondary battery of Example 2 was used. For the obtained lithium secondary-battery pack of Example 2, the impedance was 0.051 Ω, the capacity was 1.54 Ah, and the impedance capacity index was 0.033 Ω/Ah.

### Example 3

A negative electrode was produced in the same manner as in Example 1 except that the amount of the Si contained in the negative electrode active material per unit area of the negative electrode material mixture layer was 0.02 mg/cm², and the amount of the negative electrode capacity reduced thereby was adjusted by increasing the thickness of the negative electrode material mixture layer so as to maintain substantially the same negative electrode capacity as that of the negative electrode produced in Example 1. A lithium secondary battery of Example 3 was produced in the same manner as in Example 1 except that this negative electrode was used and the size of the outer can was changed according to the change in thickness of the negative electrode. For the obtained lithium secondary battery of Example 3, the impedance was 0.036 Ω, and the capacity per electrode facing area was 2.8 mAh/cm².

A lithium secondary-battery pack of Example 3 was produced in the same manner as in Example 1 except that the lithium secondary battery of Example 3 was used. For the obtained lithium secondary-battery pack of Example 3, the impedance was 0.053 Ω, the capacity was 1.56 Ah, and the impedance capacity index was 0.034 Ω/Ah.

### Example 4

A negative electrode was produced in the same manner as in Example 1 except that the amount of the Si contained in the negative electrode active material per unit area of the negative electrode material mixture layer was 0.18 mg/cm², and the amount of the negative electrode capacity increased thereby was adjusted by reducing the thickness of the negative electrode material mixture layer so as to maintain substantially the same negative electrode capacity as that of the negative electrode produced in Example 1. A lithium secondary battery of Example 4 was produced in the same manner as in Example 1 except that this negative electrode was used. For the obtained lithium secondary battery of Example 4, the impedance was 0.032 Ω, and the capacity per electrode facing area was 2.7 mAh/cm².

A lithium secondary-battery pack of Example 4 was produced in the same manner as in Example 1 except that the lithium secondary battery of Example 4 was used. For the obtained lithium secondary-battery pack of Example 4, the impedance was 0.049Ω, the capacity was 1.54 Ah, and the impedance capacity index was 0.032 Ω/Ah.

### Example 5

A lithium secondary battery of Example 5 was produced in the same manner as in Example 1 except that the capacity per electrode facing area was 3.3 mAh/cm², and the amount of the capacity increased was adjusted by adjusting the areas of the material mixture layers of the positive and negative electrodes so as to maintain substantially the same capacity as that of the lithium secondary battery produced in Example 1. For the obtained lithium secondary battery of Example 5, the impedance was 0.036 Ω, and the capacity per electrode facing area was 3.3 mAh/cm².

A lithium secondary-battery pack of Example 5 was produced in the same manner as in Example 1 except that the lithium secondary battery of Example 5 was used. For the obtained lithium secondary-battery pack of Example 5, the impedance was 0.053 Ω, the capacity was 1.55 Ah, and the impedance capacity index was 0.034 Ω/Ah.

### Example 6

A lithium secondary-battery pack of Example 6 was produced in the same manner as in Example 1 except that a protection circuit including only one FET having a resistance value of 0.02 Ω and a PTC element having a resistance value of 0.02 Ω were used. For the obtained lithium secondary-battery pack of Example 6, the impedance was 0.075 Ω, the capacity was 1.55 Ah, and the impedance capacity index was 0.048 Ω/Ah.

### Example 7

A lithium secondary-battery pack of Example 7 was produced in the same manner as in Example 1 except that a protection circuit including only one FET having a resistance value of 0.03 Ω and a PTC element having a resistance value of 0.02 Ω were used. For the obtained lithium secondary-battery pack of Example 7, the impedance was 0.085Ω, the capacity was 1.55 Ah, and the impedance capacity index was 0.055 Ω/Ah.

### Comparative Example 1

A negative electrode was produced in the same manner as in Example 5 except that the negative electrode active material was changed from the mixture of the SiO/carbon composite and graphite carbon to graphite carbon alone, and the amount of the negative electrode capacity reduced thereby was adjusted by increasing the thickness of the negative electrode material mixture layer so as to maintain substantially the same negative electrode capacity as that of the negative electrode produced in Example 5. A lithium secondary battery of Comparative Example 1 was produced in the same manner as in Example 5 except that this negative electrode was used and the size of the outer can was changed according to the change in thickness of the negative electrode. For the obtained lithium secondary battery of Comparative Example 1, the impedance was 0.039Ω, and the capacity per electrode facing area was 3.3 mAh/cm².

A lithium secondary-battery pack of Comparative Example 1 was produced in the same manner as in Example 1 except that the lithium secondary battery of Comparative Example 1 was used. For the obtained lithium secondary-battery pack of Comparative Example 1, the impedance was 0.056Ω, the capacity was 1.55 Ah, and the impedance capacity index was 0.036 Ω/Ah.

### Comparative Example 2

A lithium secondary-battery pack of Comparative Example 2 was produced in the same manner as in Example 1 except that the same lithium secondary battery as that produced in Comparative Example 1, a protection circuit including only one FET having a resistance value of 0.05Ω, and a PTC element having a resistance value of 0.03Ω were used. For the obtained lithium secondary-battery pack of Comparative Example 2, the impedance was 0.121Ω, the capacity was 1.55 Ah, and the impedance capacity index was 0.078 Ω/Ah.

### Comparative Example 3

A lithium secondary battery of Comparative Example 3 was produced in the same manner as in Example 1 except that the negative electrode active material was changed from the mixture of the SiO/carbon composite and graphite carbon to graphite carbon alone, and the amount of the negative electrode capacity reduced thereby was adjusted by increasing the electrode facing area so as to maintain substantially the same capacity as that of the lithium secondary battery produced in Example 1. For the obtained lithium secondary battery of Comparative Example 3, the impedance was 0.036Ω, and the capacity per electrode facing area was 2.8 mAh/cm².

A lithium secondary-battery pack of Comparative Example 3 was produced in the same manner as in Comparative Example 2 except that the lithium secondary battery of Comparative Example 3 was used. For the obtained lithium secondary-battery pack of Comparative Example 3, the impedance was 0.118Ω, the capacity was 1.55 Ah, and the impedance capacity index was 0.076 Ω/Ah.

### Comparative Example 4

A lithium secondary-battery pack of Comparative Example 4 was produced in the same manner as in Example 1 except that the same lithium secondary battery as that produced in Example 1, the same protection circuit as that of Comparative Example 2 including only one FET having a resistance value of 0.05Ω, and a PTC element having a resistance value of 0.03Ω were used. For the obtained lithium secondary-battery pack of Comparative Example 4, the impedance was 0.115Ω, the capacity was 1.55 Ah, and the impedance capacity index was 0.074 Ω/Ah.

### Comparative Example 5

A lithium secondary-battery pack of Comparative Example 5 was produced in the same manner as in Example 1 except that the same lithium secondary battery as that produced in Example 1, a protection circuit including only one FET having a resistance value of 0.04Ω, and a PTC element having a resistance value of 0.03Ω were used. For the obtained lithium secondary-battery pack of Comparative Example 5, the impedance was 0.105Ω, the capacity was 1.55 Ah, and the impedance capacity index was 0.068 Ω/Ah.

Each of the lithium secondary-battery packs of Examples 1 to 7 and Comparative Examples 1 to 5 was combined with a charge/discharge apparatus to form a charging system, and each charging system was subjected to a fast charging test by the following charging method.

Fast Charging Test

Using each of the above-described charging systems, a CC-CV charging (with a cut-off current value of 0.050 was performed for each capacity in which charging was performed at 25° C. with a constant current of 1.5C (corresponding to 2.3 A in the case of 1.55 Ala) until the voltage value reached 4.2 V, and thereafter constant voltage charging was performed with the voltage maintained at 4.2 V. Then, the CC charging time (min), which is the time required from the start of charging until the charging was switches to a constant voltage mode, and the time (min) required from the start of charging to charging up to an SOC of 90% were measured.

Table 1 shows the type of the Si-based active material, the amount of the Si contained in the negative electrode active material per unit area of the negative electrode material mixture layer, the capacity per electrode facing area, and the slope at an SOC of 40% on a voltage-SOC curve obtained when charging is performed with a current value of 1.5C for each of the lithium secondary batteries of the above-described examples and comparative examples.

TABLE 1

| | Negative electrode active material | | | |
|---|---|---|---|---|
| | | Amount of Si contained in | | |
| | | negative electrode active | | |
| | | material per unit area of | | |
| | | negative electrode material | Capacity per electrode | |
| | Type of Si-based active | mixture layer | facing area | Voltage slope at SOC 40% |
| | material | (mg/cm²) | (mAh/cm²) | (mV/10% SOC) |
| Example 1 | SiO/carbon composite | 0.14 | 2.8 | 30 |
| Example 2 | Si alloy | 0.14 | 2.8 | 40 |
| Example 3 | SiO/carbon composite | 0.02 | 2.8 | 45 |
| Example 4 | SiO/carbon composite | 0.18 | 2.7 | 32 |
| Example 5 | SiO/carbon composite | 0.14 | 3.3 | 50 |
| Example 6 | SiO/carbon composite | 0.14 | 2.8 | 30 |
| Example 7 | SiO/carbon composite | 0.14 | 2.8 | 30 |
| Com. Ex. 1 | — | 0 | 3.3 | 100 |
| Com. Ex. 2 | — | 0 | 3.3 | 100 |
| Com. Ex. 3 | — | 0 | 2.8 | 80 |
| Com. Ex. 4 | SiO/carbon composite | 0.14 | 2.8 | 30 |
| Com. Ex. 5 | SiO/carbon composite | 0.14 | 2.8 | 30 |

In Table 1, “voltage slope at SOC 40%” means the slope k40 at an SOC of 40% on a voltage-SOC curve obtained when charging is performed with a current value of 1.5C.

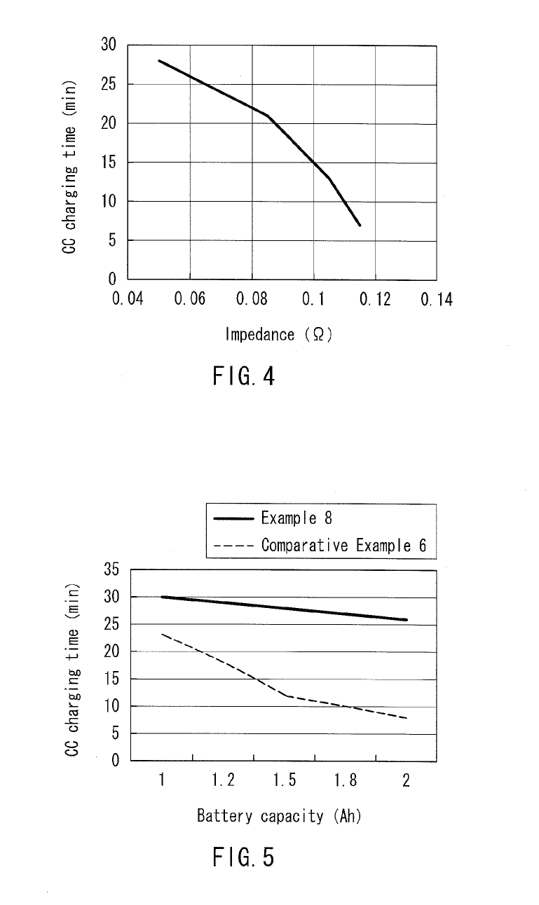

Table 2 shows the impedance, the capacity, the impedance capacity index, the CC charging time, and the time required for charging up to SOC 90% for each of the lithium secondary-battery packs of the above-described examples and comparative examples. FIG. 4 shows the relationship between the impedance (Ω) and the CC charging time (min) for each of the lithium secondary-battery packs of Example 1, 6, 7 and Comparative Examples 4 and 5.

TABLE 2

| | Lithium secondary-battery pack | | | | |
|---|---|---|---|---|---|
| | | | | | Time required for charging |
| | Impedance | Capacity | Impedance capacity index | CC charging time | up to SOC 90% |
| | (Ω) | (Ah) | (Ω/Ah) | (min) | (min) |
| Example 1 | 0.050 | 1.55 | 0.032 | 28 | 43 |
| Example 2 | 0.051 | 1.54 | 0.033 | 26 | 46 |
| Example 3 | 0.053 | 1.56 | 0.034 | 23 | 47 |
| Example 4 | 0.049 | 1.54 | 0.032 | 28 | 43 |
| Example 5 | 0.053 | 1.55 | 0.034 | 24 | 47 |
| Example 6 | 0.075 | 1.55 | 0.048 | 23 | 46 |
| Example 7 | 0.085 | 1.55 | 0.055 | 21 | 48 |
| Com. Ex. 1 | 0.056 | 1.55 | 0.036 | 18 | 65 |
| Com. Ex. 2 | 0.121 | 1.55 | 0.078 | 15 | 75 |
| Com. Ex. 3 | 0.118 | 1.55 | 0.076 | 19 | 60 |
| Com. Ex. 4 | 0.115 | 1.55 | 0.074 | 7 | 65 |
| Com. Ex. 5 | 0.105 | 1.55 | 0.068 | 13 | 60 |

As shown in Table 2, the lithium secondary-battery packs of Examples 1 to 7, in each of which a lithium secondary battery including a negative electrode containing a Si-based active material as the negative electrode active material and the impedance capacity index was set to an appropriate value, exhibited a longer CC charging time in the fast charging test than that of the lithium secondary-battery packs of Comparative Examples 1 to 5, and thus successfully reduced the time required for charging up to SOC 90%. Additionally, it can be seen from FIG. 4 that when the impedance of the lithium secondary-battery packs exceeds 0.085Ω, the CC charging time rapidly decreases. Furthermore, a comparison among the lithium secondary-battery packs of the examples also shows that the fast-charging characteristics of the lithium secondary-battery pack can be further improved by adjusting the capacity per electrode facing area of the lithium secondary battery, the amount of the Si contained in the negative electrode active material per unit area of negative electrode material mixture layer, and the voltage slope at an SOC of 40% to more appropriate values.

A battery of a mobile phone, which is an electronic device, was replaced by each of the battery pack of Example 1 and the battery pack of Comparative Example 1. A lead was drawn from the terminal of the mobile phone and connected to the battery pack of Example 1 or Comparative Example 1, and the time required for charging up to 90% was compared between the battery packs. As a result, the charging time of the mobile phone using the battery pack of Example 1 was reduced by more than 10%, as compared with the charging time of the mobile phone using the battery pack of Comparative Example 1 was used. The combination of the battery pack of Example 1 and the charging circuit of the mobile phone corresponds to the charging system and the charging method of the present invention, and the effect achieved thereby is evident.

Here, the time required for charging a lithium secondary-battery pack up to SOC 90% increases under a low-temperature environment (e.g., 5° C.). However, by charging the lithium secondary-battery packs of the examples while heating them to room temperature (25° C.) using a heater, the battery packs were successfully charged within a charging time substantially the same as the charging time when charged under a room temperature environment. Accordingly, it was also found that the lithium secondary-battery pack of the present invention can be fast charged even under a low-temperature environment by heating the pack, and thus can be fast charged over a wider temperature range.

### Example 8

Using the same FETs and PTC elements as those used in Example 1, five lithium secondary-battery packs A to E having the same impedance (0.050Ω) and but different battery capacities were produced. Table 3 shows the impedances, the capacities, and the impedance capacity indices of the obtained lithium secondary-battery packs A to E.

### Comparative Example 6

Using the same FETs and PTC elements as those used in Comparative Example 4, five lithium secondary-battery packs F to J having different battery capacities were produced in the same manner as in Example 8 except that the impedance was changed to 0.133Ω. Table 3 shows the impedances, the capacities, and the impedance capacity indices of the obtained lithium secondary-battery packs F to J.

Each of the lithium secondary-battery packs A to E, and F to J was combined with a charge/discharge apparatus to construct a charging system. Using each of the obtained charging systems, a CC-CV charging (with a cut-off current value of 0.05C) was performed for each capacity in which charging was performed at 25° C. with a constant current of 1.5C (corresponding to 2.3 A in the case of 1.5 Ah) until the voltage value reached 4.2 V, and thereafter constant voltage charging was performed with the voltage maintained at 4.2 V. Then, the CC charging time (min), which is the time required from the start of charging until the charging was switched to a constant voltage mode, was measured. The results are shown in Table 3 and FIG. 5. FIG. 5 is a graph showing the relationship between the battery capacity (Ah) and the charging time (min) of the lithium secondary-battery packs A to E, and F to J.

TABLE 3

| | | Lithium secondary-battery pack | | | |
|---|---|---|---|---|---|
| | | | | Impedance | |
| | | | | capacity | CC |
| | | Impedance | Capacity | index | charging time |
| | | (Ω) | (Ah) | (Ω/Ah) | (min) |
| Example 8 | A | 0.050 | 1.0 | 0.050 | 30 |
| | B | 0.050 | 1.2 | 0.042 | 29 |
| | C | 0.050 | 1.5 | 0.033 | 28 |
| | D | 0.050 | 1.8 | 0.028 | 27 |
| | E | 0.050 | 2.0 | 0.025 | 26 |
| Com. Ex. 6 | F | 0.133 | 1.0 | 0.133 | 23 |
| | G | 0.133 | 1.2 | 0.111 | 18 |
| | H | 0.133 | 1.5 | 0.089 | 12 |
| | I | 0.133 | 1.8 | 0.074 | 10 |
| | J | 0.133 | 2.0 | 0.067 | 8 |

It can be seen from FIG. 5 that for the lithium battery packs F to J, which had an impedance capacity index greater than 0.055 Ω/Ah, the time during which CC charging can be performed rapidly drops when the capacity is about 1.5 Ah. This seems to be caused by a relative increase of the charge current value corresponding to 1.5C due to an increase in battery capacity. That is, it can be seen that although a battery pack having a capacity of about 1.0 Ah can be fully charged in about an hour even with a conventional impedance, when the capacity of the battery pack exceeds about 1.5 Ah, it is difficult to charge the battery pack with a current value corresponding to 1.5C, resulting in a decrease in its original chargeable time with a large current.

In the other hand, in the case of the lithium battery packs A to E, which had an impedance capacity index of 0.055 Ω/Ah or less, the time during which CC charging can be performed does not rapidly drop even if the capacity exceeds 1.5 A, indicating that they can be fully charged in about an hour even if the capacity is large.

The invention may be embodied in other forms without departing from the spirit or essential characteristics thereof. The embodiments disclosed in the present application are merely examples, and thus the present invention is not limited thereto. The scope of the present invention should be construed in view of the appended claims, rather than the foregoing description, and all changes that come within the meaning and range of equivalency of the claims are intended to be embraced therein.

### INDUSTRIAL APPLICABILITY

The non-aqueous electrolyte secondary battery pack of the present invention can be preferably used for a variety of applications, including a power source for small and multifunctional portable devices, for which conventional non-aqueous secondary battery packs have been used.

### DESCRIPTION OF REFERENCE NUMERALS

100 Lithium secondary battery
101 PTC element
102 Protection circuit
103a, 103b FET
104 Control unit
1 Positive electrode
2 Negative electrode
3 Separator
4 Outer can
6 Insulator
6 Wound electrode body
7 Positive electrode lead body
8 Negative electrode lead body
9 Sealing cover plate
10 Insulating packing
11 Terminal
12 Insulator
13 Lead plate
14 Non-aqueous electrolytic solution inlet
15 Rupture vent

1. A lithium secondary-battery pack comprising:
a lithium secondary battery including an electrode body and a non-aqueous electrolyte, the electrode body including a positive electrode and a negative electrode facing each other, and a separator interposed therebetween;
a PTC (Positive Temperature Coefficient) element; and
a protection circuit including a field-effect transistor,
wherein the negative electrode includes a negative electrode material mixture layer containing a Si-containing material as a negative electrode active material, and,
where Z represents an impedance (Ω) of the lithium secondary-battery pack and Q represents a capacity (Ah) of the lithium secondary-battery pack, an impedance capacity index represented by Z/Q is 0.055 Ω/Ah or less.

2. The lithium secondary-battery pack according to claim 1, wherein the capacity Q is 1.5 Ah or more.

3. The lithium secondary-battery pack according to claim 1, wherein the impedance Z is 0.085Ω or less.

4. The lithium secondary-battery pack according to claim 1, wherein the Si-containing material is a material containing Si and O as constituent elements.

5. The lithium secondary-battery pack according to claim 1, wherein the Si-containing material is a composite including a material containing Si and O as constituent elements serving as a core material and a carbon coating layer formed on a surface of the core material.

6. The lithium secondary-battery pack according to claim 4, wherein the material containing Si and O as constituent elements is a material represented by a general compositional formula SiOₓ, where x is 0.5≦x≦1.5.

7. The lithium secondary-battery pack according to claim 1, wherein a capacity per unit area determined by dividing the capacity of the lithium secondary battery by a facing area between a positive electrode material mixture layer of the positive electrode and the negative electrode material mixture layer is less than 3.0 mAh/cm².

8. The lithium secondary-battery pack according to claim 1, wherein an amount of the Si contained in the negative electrode active material per unit area of the negative electrode material mixture layer is 0.007 mg/cm² or more.

9. The lithium secondary-battery pack according to claim 1, wherein a slope at an SOC (State of Charge) of 40% on a voltage (mV)-SOC (%) curve obtained when charging is performed with a current value of 1.5C is 90 mV/10% SOC or less.

10. The lithium secondary-battery pack according to claim 1, wherein the impedance capacity index is 0.04 Ω/Ah or less.

11. The lithium secondary-battery pack according to claim 1, wherein the impedance capacity index is 0.35 Ω/Ah or less.

12. An electronic device using the lithium secondary-battery pack according to claim 1.

13. A charging system using the lithium secondary-battery pack according to claim 1.

14. A charging method using the lithium secondary-battery pack according to claim 1.
